(19) United States
(12) Patent Application Publication
(10) Pub. No.: US 2017/0186084 A1
(43) Pub. Date: Jun. 29, 2017

(54) SYSTEM AND PROCESS FOR INTERMEDIATED CREDIT REPORT ACCESS

(71) Applicant: Steven Koch, Dallas, TX (US)

(72) Inventor: Steven Koch, Dallas, TX (US)

(21) Appl. No.: 15/390,700

(22) Filed: Dec. 26, 2016

Related U.S. Application Data
(60) Provisional application No. 62/271,253, filed on Dec. 27, 2015.

(51) Int. Cl. G06Q 40/02

(52) U.S. Cl. CPC G06Q 40/02

(57) ABSTRACT

Embodiments of the invention are directed to intermediating credit report requests to a credit bureau between a prospective creditor and a prospective debtor. The system includes a server with an intermediary database for receipt and storage of prospective creditor identifying information, prospective debtor identifying information, with the prospective debtor identifying information including at least one key to credit bureau credit report information for said prospective debtor. The server is configured to receive an electronic communication from the prospective debtor authorizing a prospective creditor to access the credit report of the prospective debtor and storing the authorization in the intermediary database. The server conditionally retrieves the credit report of the prospective debtor from the credit bureau upon confirmation of the prospective debtor to prospective creditor authorization, and transmits the credit report to the prospective creditor.

### PRIORITY

The present invention claims priority to provisional application 62/271,253, which has a filing date of Dec. 27, 2015.

### BACKGROUND

Field of the Invention

The present invention relates to a systems and processes for credit report access, more specifically to systems and processes for intermediated credit report access.

Description of the Related Art

Consumer screening is an important component of the process of establishing relationships such as a debtor to creditor relationship in consumer loans or other processes such as mortgage applicant screening, rental applicant screening, employee screening, and others. A common part of the screening process is receiving an aggregated credit report. With the reports, the screener can make an informed decision about whether to accept or decline the application and under what terms.

A social security number is the primary key for access to a credit report. It is frequently provided by a consumer to a vendor during a transaction. This can be problematic, as a social security number is generally permanently assigned to an individual. That's a serious problem because, within the world of identity thieves, social security numbers are among the most prized pieces of information. Armed with a victim's name and social security number, an identity thief can open a new line of credit, apply for a home or car loan, obtain medical goods or services in the victim's name, defraud the victim's health insurance by getting reimbursed for medical care that never happened, or file a fraudulent tax return in order to claim the victim's refund. Each additional vendor which possesses a consumer's social security number presents an additional repository for access by identity thieves. For that and other reasons, it would be advantageous to have alternate systems and processes for credit file retrieval.

### SUMMARY

Embodiments of the invention are directed to intermediating credit report requests to a credit bureau between a prospective creditor and a prospective debtor. The system includes a server with an intermediary database for receipt and storage of prospective creditor identifying information, prospective debtor identifying information, with the prospective debtor identifying information including at least one key to credit bureau credit report information for said prospective debtor. The server is configured to receive an electronic communication from the prospective debtor authorizing a prospective creditor to access the credit report of the prospective debtor and storing the authorization in the intermediary database. The server conditionally retrieves the credit report of the prospective debtor from the credit bureau upon confirmation of the prospective debtor to prospective creditor authorization, and transmits the credit report to the prospective creditor.

These and other features, aspects, and advantages of the invention will become better understood with reference to the following description, and accompanying drawings.

### BRIEF DESCRIPTION OF THE DRAWINGS

FIG. 1 depicts a diagram of a representative vendor registration process;

FIG. 2 depicts a diagram of a representative initiation of a credit report request;

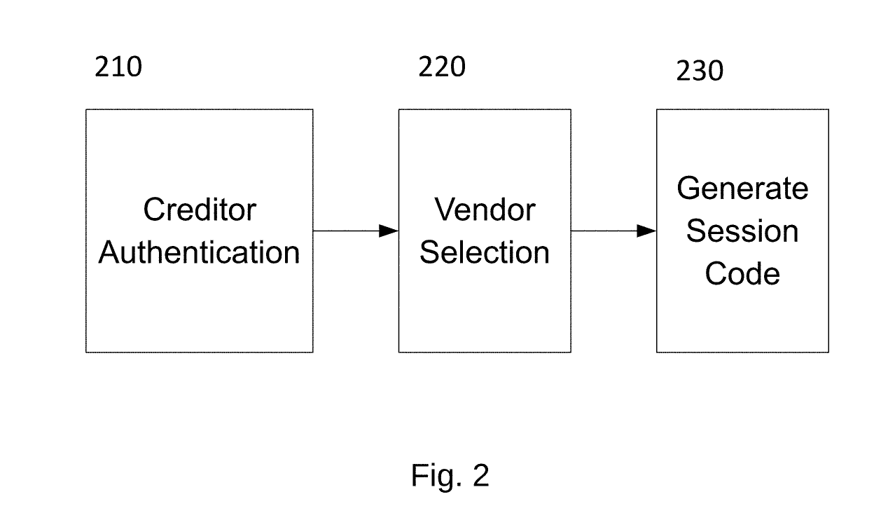

FIG. 3 depicts a diagram of an embodiment of a process for processing credit report request and retrieval of a credit file;

FIG. 4 depicts a diagram of representative post credit file retrieval steps;

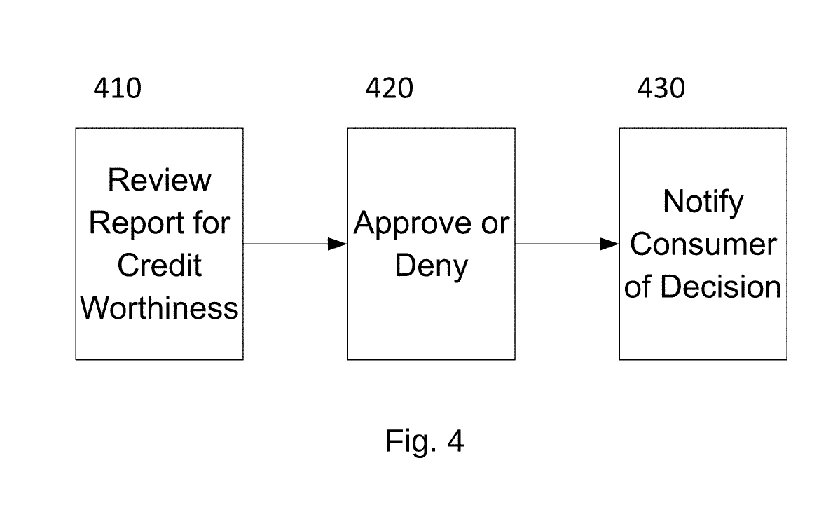

FIG. 5 depicts a diagram of major elements of an embodiment of a system according to the current invention as it may exist in operation; and

FIG. 6 depicts a block diagram of major steps of an embodiment of a process according to the current invention; and

FIG. 7 depicts representative tables for translation in intermediating a credit report request.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The present invention is directed to systems and processes for intermediated credit report access. In representative operation, the entities involved include a prospective debtor 08, a prospective creditor 06, and a credit bureau 04. The credit bureau 04 provides aggregated background information in the form of a credit report 46 to the prospective creditor 06 regarding the prospective debtor's 08 credit risk. Systems and processes of the current invention provide intermediated access to credit reports, thereby decreasing the risk of identity theft.

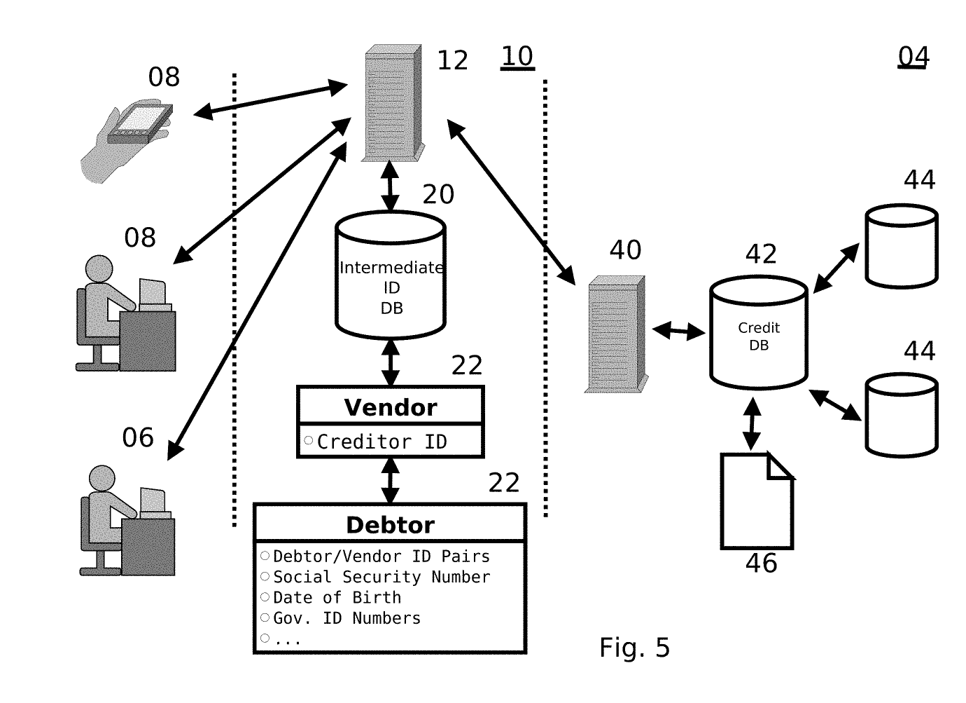

FIG. 5 depicts a diagram of major elements of an embodiment of the current invention as it may exist in operation where a prospective debtor 08 may request credit from a creditor 06 who, in turn, requests a credit report 46 from a credit bureau 04. In exemplary operation, the credit report request is intermediated by the illustrated system 10 of the current invention. Depicted are an embodiment of a system 10 and a representative computing environment of the credit bureau 04.

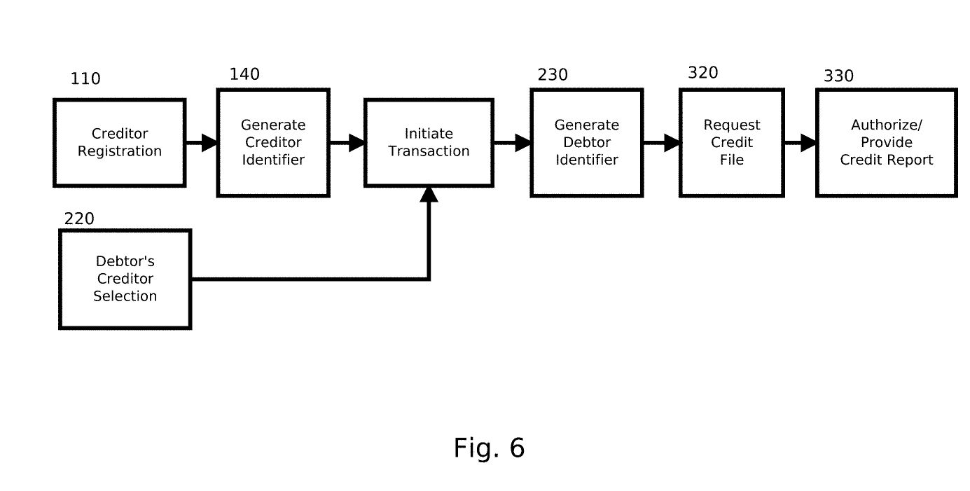

FIG. 6 depicts an embodiment of a process of the current invention. At step 110, a prospective creditor 06 is registered in the system 10. At step 140 and 230, unique identifiers are generated. After a prospective transaction request, a credit report 46 is requested 320. At step 330, the credit report 46 is conditionally provided to the prospective creditor. More consideration will be given to each of these steps below.

A prospective debtor 08 is a person or entity, who desires to enter into a transaction, financial or otherwise, that will require the extension of credit, or trust, either by another party, usually a prospective creditor 06. A prospective debtor 08 most typically, but not exclusively, will be a purchaser of goods or services such as commodity items, revolving credit, loans, mortgages, real estate, etc. The category may also include one of the parties to a contract in which mutual exchanges of promises are made.

A prospective creditor 06 is a seller or third party who desires to enter into a financial transaction with a prospective debtor 08 that will typically require the extension of credit to the prospective debtor 08 or another party on the prospective debtor's 08 behalf, or the use of prospective debtor's 08 own funds in a form other than cash. A prospective creditor 06 most typically, but not exclusively, will be a seller of goods or services such as commodity items, revolving credit, loans, mortgages, real estate, etc. In this specification, a prospective creditor 06 can include other parties such as a dating site, a classified sales site such as Craigslist, a social media site such as Facebook, a site which facilitate meetings between people, or other websites.

A credit bureau 04 is a service provider which provides credit reports 46, which assist in the evaluation of the credit worthiness of a prospective debtor 08. As may be seen below, the traditional services of a credit bureau 04 can also encompass those of an identify verifier and/or background information provider.

A credit report 46 is typically a record of the debtor's 08 financial history from a number of sources, such as banks, credit card companies, collection agencies, governments, and other creditors. The credit report 46 may include supplemental information believed to be relevant such as criminal records. The credit report 46 may include a debtor's credit score, which is the result of an algorithm applied to a credit report 46 and other sources of information to evaluate risk of future delinquency.

In exemplary operation, the process is carried out on a server 12. A computer or server, generally refers to a system which includes a processor, memory, a screen, a network interface, storage, and input/output (I/O) components connected by way of a data bus. The I/O components may include for example, a mouse, keyboard, buttons, or a touchscreen. A server contains various server software programs and preferably contains application server software. Those skilled in the art will appreciate that the computer or servers can take a variety of configurations, including personal computers, smartphones, hand-held devices, multi-processor systems, microprocessor-based electronics, network PCs, minicomputers, mainframe computers, and the like. Additionally, the computer may be part of a distributed computer environment where tasks are performed by local and remote processing devices that are communicatively linked. One skilled in the art can understand that the structure of and functionality associated with the aforementioned elements can be optionally partially or completely incorporated within one or the other, such as within one or more processors. In exemplary operation, actions of the system, prospective creditor 06, prospective debtor 08, and credit bureau 04 are carried out on a computer. In this specification, prospective creditor 06, prospective debtor 08, or credit bureau 04 may refer to computers controlled by or associated with the party.

The system 10 includes specialized storage in the form of an intermediary database 40 configured to store creditor 06 identifier information, debtor 08 identifier information and is operable to provide intermediate information for translation between outward facing identifiers or information and inward facing credit bureau 04 identifiers or information. In certain configurations, creditor identifiers and debtor identifiers are received and stored. In certain configurations, session identifiers representing an interaction between a prospective debtor 08 and prospective creditor 06 are received and stored. In certain configurations, the intermediary database 40 includes a creditor table having a creditor information such as a vendor identifier and vendor name. In certain configurations, the intermediary database 40 includes a debtor table having a debtor information such as a debtor name and arrays of associated debtor identifier to creditor identifier pairs. Additional debtor information can include social security number, date of birth, government identification document numbers, and other information. As mentioned, the intermediary database 40 facilitates translation between outward facing identifiers and inward facing credit bureau identifiers. For example, the system 10 may query the intermediary database 40 with an externally input creditor identifier and debtor identifier key pair. The resulting lookup may return a debtor social security number for further use. One skilled in the art would appreciated that the data may reside in one or more databases, tables, or computers. Representative suitable database systems include MySQL, PostgreSQL, SQLite, Microsoft SQL Server, Oracle, dBASE, nosql, or text systems.

The exemplary credit bureau 04 computing environment also includes a server 40 having database of aggregated credit reporting data 42 having debtors 08 financial history. The aggregated credit reporting data 42 may include supplemental databases 44 such as criminal databases, public information, or other information relevant to the credit reporting process.

A network 18 facilitates communication between the system 10, the credit bureau 04, the creditor 06, and the debtor 18. Network 18 may also include one or more wide area networks (WANs), local area networks (LANs), personal area networks (PANs), mesh networks, all or a portion of the Internet, and/or any other communication system or systems at one or more locations. Network 18 may be all or a portion of an enterprise or secured network, while in another instance at least a portion of the network 18 may represent a connection to the Internet. Further, all or a portion of network 18 may comprise either a wireline or wireless link. In other words, network 18 encompasses any internal or external network, networks, sub-network, or combination thereof operable to facilitate communications between various computing components inside and outside the illustrated environment. The network 18 may communicate by, for example, Bluetooth, Zigbee, WiFi, cellular, Internet Protocol (IP) packets, Frame Relay frames, Asynchronous Transfer Mode cells, voice, video, data, and other suitable information between network addresses. Certain configurations of systems 10 include short range communications apparatus such as RFID, NFC, WiFi, or Bluetooth radios.

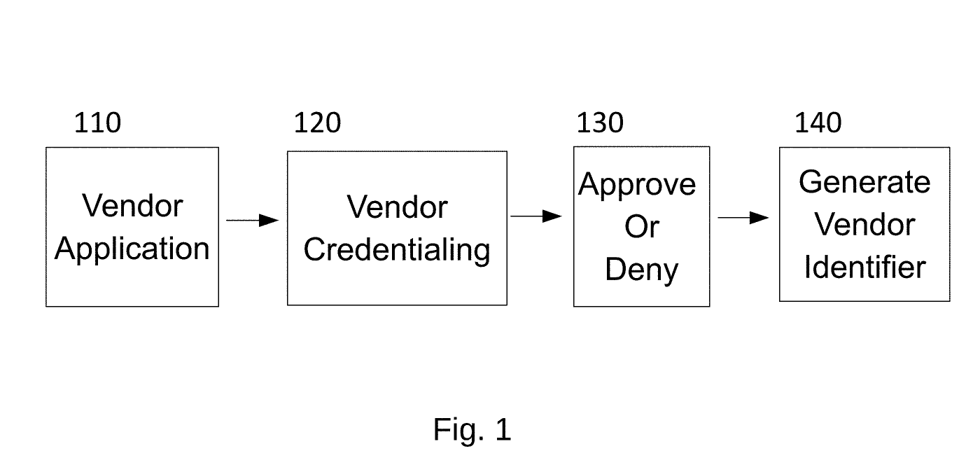

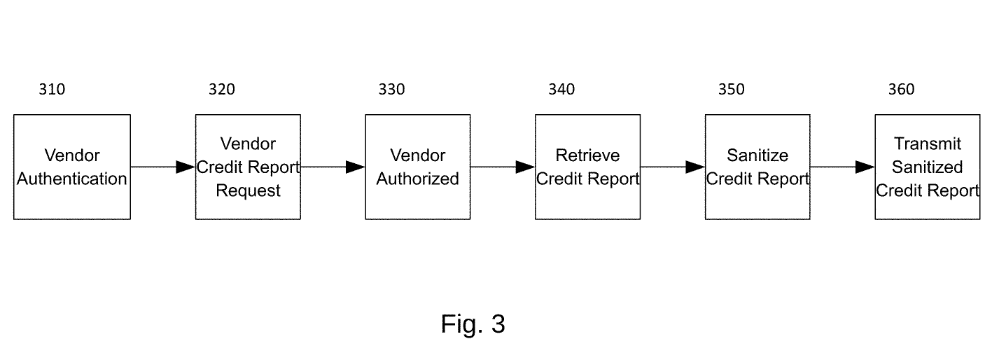

Having described elements of an embodiment of a system 10 according to the current invention, an embodiment of a process is now described. Debtors 08 and creditors 06 access the system via a computer as described above. Referring to FIGS. 1 and 3, at step 110, a prospective creditor 06 applies for registration with the system. The system 10 provides an interface to prompt for and receive identification information of the prospective creditor 06, such as the entity name, business entity type, assumed names, state of registration, and other information. Additionally, the prospective creditor 06 may provide associated identifiers for short range communication devices disposed in the facilities such as the identifier of NFC, RFID, WiFi, or Bluetooth radios. Where the prospective creditor 06 has short range communication radios, the system 10 may store a status indicator of such in the intermediary database 20. A background check may be performed prior to approving or denying registration in order to determine the likelihood of abuse of prospective creditor 08 information. Factors in approval or denial can include prior misuse of services or information or breaches of debtor information. For example, a prospective creditor 06 check of previous credit report access and use history to identify possible abuse may be conducted. A prospective creditor 06 with a high frequency of failures to verify the target prospective debtor's 08 identity may be employed as an indication of improper use of the identity verification service. Another factor may be if the prospective creditor 06 repeatedly supplies the same identifying information related to the same type transaction in a short span of time. On approval, account credentials are created and supplied to the prospective creditor 06. A unique creditor identifier, persistent or ephemoral, can be generated and assigned to the creditor 140. The prospective creditor 06 information is stored in the intermediary database 20.

At step 200, a prospective debtor 08, typically a consumer, registers with the system 10. The system 10 provides an interface for receipt of identification information of the prospective debtor 08, such as the prospective debtor's 08 name, address, telephone number, date of birth, social security number, current and past employers, government issued identification document numbers, education, insurance, health or medical data, or other information. Additionally, the prospective debtor 08 may provide identifiers for short range communication devices in his or her possession such as the identifiers of NFC, RFID, WiFi, or Bluetooth radios in a smartphone. A unique debtor identifier, persistent or ephemoral, can be generated and assigned to the debtor 205. The prospective debtor 08 information is stored in the intermediary database 20.

Referring to FIGS. 3 and 6, a prospective credit transaction is initiated where the prospective creditor 06 and prospective debtor 08 desire to initiate and complete a consumer credit report request with information such as credit history and scores provided to the prospective creditor 06 in order to evaluate proceeding with the transaction and terms for the prospective transaction. The prospective debtor 08 makes a request of a prospective creditor 06 for some amount of credit, a revolving credit instrument such as a charge card, a loan, or some other credit vehicle or benefit. To facilitate the transaction, the prospective creditor 06 seeks to determine the identity of the prospective debtor 08 and credit risk information associated with that identity that may help to indicate the risk of the contemplated transaction (for example, an extension of a loan).

The prospective debtor 08 initiates the credit report request 207 in order to provide authorization for the prospective creditor 06 access to his or her credit report 46. In certain configurations, the prospective debtor 08 enters a visual interface provided by the system 10. The exemplary interface initially provides authenticates the debtor 08 using identifying information such as the account credentials created by the debtor 08 during debtor registration process. The exemplary interface presents an input for the prospective debtor 08 to select the prospective creditor 06, providing creditor 06's permission for credit report 46 access. Certain configurations of the interface also present inputs for the prospective debtor 08 to restrict or enable the prospective creditor 06 to access selected fields within the credit report 46. The credit report request 207 information is transmitted to the system 10 for further processing. In certain configurations, the system 10 conditionally responds with a session code on confirmation of the identifying information, the session code being a token signifying the prospective debtor's 08 permission for credit report 46 access by this prospective creditor 06.

In an alternate configurations of initiating the credit report request 207, the prospective debtor 08 activates his or her short range radio, such as the WiFi, NFC, RFID, or Bluetooth radio of a smartphone, and initiates communication with a short range radio disposed in the facility of the prospective creditor 06. The prospective debtor 08 transmitted information can include identifying information of the prospective debtor 08 such as radio identifiers, authentication credentials, personal identifiers, or the like. The credit report request 207 information, including but not limited to the radio identifier of the prospective debtor 08 and/or the radio identifier of the prospective creditor 06, is transmitted to the system 10 for further processing. In certain configurations, the system 10 responds with a transmission of identifying information of the prospective debtor 08 to the prospective creditor 06 subject to the permissions of that prospective creditor 06. For example, the transmission can include certain identifying information of the prospective debtor 08 such as name and contact information in order to facilitate the prospective creditor's completion of the credit report request. In certain configurations, the system 10 conditionally responds with a session code on confirmation of the identifying information, the session code being a token signifying the prospective debtor's 08 permission for credit report 46 access by this prospective creditor 06.

As previously disclosed, the system 10 generated session code is a token signifying the prospective debtor's 08 permission for credit report 46 access for a prospective creditor 06. An exemplary session code is associated with the prospective creditor 06 selected for the prospective credit transaction. Furthermore, in exemplary configuration, the session code is not the same nor derived from the prospective debtor's 08 social security number. The generated session code can be associated with the creditor and can be stored as an associated debtor identifier to creditor identifier pair. An exemplary session code is a randomly generated alphanumeric of sufficient length to minimize brute force attempts in the environment. The session code may be associated with the debtor records and/or to the creditor record for retrieval from the intermediary database 20. As such there may be a plurality of associated debtor identifier to creditor identifier pairs, each pair representing a debtor to creditor relationship.

The prospective creditor 06 completes the credit report request 320. In exemplary configuration, the prospective creditor 06 transmits the session code associated with this prospective debtor 08. In certain configurations, the prospective creditor 06 obtains and transmits additional information identifying information the prospective debtor 08 in completing the credit report request. In exemplary configurations, this identifying information excludes the social security and may include, for example, the session code, name, address, date of birth, government identification numbers, and other identifying information of the prospective debtor. The prospective creditor 06 transmits the completed credit report request, to the system 10.

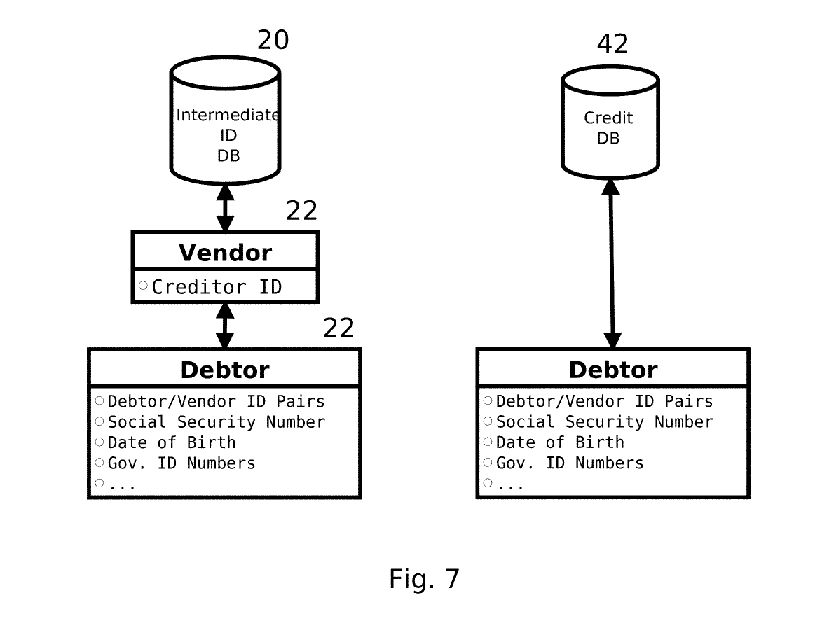

The system 10 receives the credit report request from the prospective creditor 06 for authorization processing 330. In order to authorize the request, the system 10 retrieves the creditor 06 registration records and the debtor 08 registration records from the intermediary database 20. In certain configurations, the system 10 confirms the received session code against that for the particular prospective creditor 06 to prospective debtor 08 pair. In certain configurations, the system 10 compares the other received debtor 08 information against the debtor registration information, as shown in the representative tables of FIG. 7. In certain configurations, the system 10 compares the received credit request against the associated short range radio identifiers. Upon successful comparison, the system 10 authorizes the credit request and relays the credit request to the credit bureau 04.

In certain configurations, the credit bureau 04 returns a credit report 46 to the system 340. In exemplary operation, the system 10 processes the credit report 46 and removes the social security number and other similarly sensitive information from the credit report 350. The system 10 further processes the credit report 46 and removes other fields for which the creditor 06 is unauthorized to view from the document, using text processing, field marking, and other processes known in the art. The credit report 46 is transmit to the prospective creditor 360.

A typical credit report 46 supplies raw data in order to allow the prospective creditor 06 to perform its own risk assessment of the prospective debtor 410. It is left up to the prospective creditor 06 to use the supplied information including the credit report 46, credit score, and other information in such a manner as it deems fit. As such, the credit report 46, credit score, and other information may be weighted and compared using the prospective creditor's 06 private criteria or other criteria in making its determination as to the risk of proceeding with the contemplated transaction. The prospective creditor's 06 makes its decision to approve or deny and notifies the prospective debtor 420 430.

The authorization for credit report 46 access can be one-time access or persistent through the creditor-debtor relationship. When a prospective debtor 08 subsequently requests credit from the prospective creditor 06 and the prospective creditor 06 requests a credit report 46 from a credit bureau 04, the system 10 may store a notation directing the prospective creditor 06 to request access or the credit report 46 may be withheld until the permission of the identified prospective debtor 06 is provided. Alternatively, updates to the credit report 46 may be pushed to the creditor 06.

In the case of a breach of the creditor's records containing the debtor's vendor specific session code, the session code can be revoked or changed.

Insofar as the description above and the accompanying drawing disclose any additional subject matter that is not within the scope of the single claim below, the inventions are not dedicated to the public and the right to file one or more applications to claim such additional inventions is reserved.

What is claimed is:

1. A system for intermediating credit report requests to a credit bureau between a prospective creditor and a prospective debtor, said system comprising:
a server with processor and memory;
said server including an intermediary database for receipt and storage of prospective creditor identifying information, prospective debtor identifying information, said prospective debtor identifying information including at least one key to credit bureau credit report information for said prospective debtor;
said server configured to receive an electronic communication from said prospective debtor authorizing a prospective creditor to access said credit report of said prospective debtor and storing said authorization in said intermediary database; and
said server conditionally retrieving said credit report of said prospective debtor from said credit bureau upon confirmation of said prospective debtor to said prospective creditor authorization, and transmitting said credit report to said prospective creditor.

2. The system of claim 1, wherein said server generates and transmits a session code in response to said prospective debtor authorization to said prospective debtor; and
said credit report retrieval is further conditioned upon said prospective creditor providing said session code.

3. The system of claim 1, wherein a visual interface is presented to said prospective debtor for authorization input.

4. The system of claim 3, wherein said server generates and transmits a session code in response to said prospective debtor authorization to said prospective debtor; and
said credit report retrieval is further conditioned upon said prospective creditor providing said session code.

5. The system of claim 1, wherein said prospective debtor authorization input is initiated by short range radio communication from said prospective debtor.

6. The system of claim 5, wherein said server provides identifying information of prospective debtor to prospective creditor.

7. The system of claim 6, wherein said server generates and transmits a session code in response to said prospective debtor authorization; and
said credit report retrieval is further conditioned upon said prospective creditor providing said session code.

8. The system of claim 1, wherein said prospective creditor information includes a status indicator of a short range radio at the facility of said prospective creditor.

9. The system of claim 8, wherein said prospective debtor's identifying information includes an identifier associated with said short range radio of said prospective debtor.

10. The system of claim 9, wherein said server is configured to receive a credit request from said prospective creditor including said short range radio associated identifier of said prospective debtor; and
said credit report retrieval is further conditioned upon successful comparison of said short range radio associated identifiers of said prospective debtor.

11. The system of claim 8, wherein said prospective creditor identifying information includes an identifier of said short range radio at said facility of said prospective creditor.

12. The system of claim 11, wherein said server is configured to receive a credit request from said prospective creditor including said short range radio associated identifier of said prospective creditor; and
said credit report retrieval is further conditioned upon successful comparison of said short range radio associated identifiers of said prospective creditor.

13. The system of claim 1, wherein said server is configured to remove at least one identifying information from said retrieved credit report prior.

14. A process for intermediating credit report requests to a credit bureau between a prospective creditor and a prospective debtor, said system comprising:
providing a server with processor and memory;
said server including an intermediary database;
at time of registration, receiving and storing identifying information from a prospective creditor in said intermediary database;
at time of registration, receiving and storing identifying information from a prospective debtor in said intermediary database, said prospective debtor identifying information including at least one key to credit bureau credit report information for said prospective debtor;
at initiation of a credit request, presenting a visual interface to said prospective debtor for receipt of authorization input, said server storing said authorization in said intermediary database;
said server generating and transmitting a session code in response to said prospective debtor authorization input;
said server conditionally retrieving said credit report of said prospective debtor from said credit bureau upon confirmation of said prospective debtor to said prospective creditor authorization; and
transmitting said credit report to said prospective creditor.

15. The process of claim 14, wherein said prospective debtor authorization input is initiated by short range radio communication from said prospective debtor.

16. The process of claim 15, wherein said short range radio communication is selected from NFC, RFID, Bluetooth, and WiFi.

17. The process of claim 14, wherein said prospective creditor information includes a status indicator of a short range radio at the facility of said prospective creditor.

18. The process of claim 17, wherein said prospective debtor's identifying information includes an identifier associated with said short range radio of said prospective debtor.

19. The process of claim 18, wherein said server receives a credit request from said prospective creditor including said short range radio associated identifier of said prospective debtor; and
said server conditions credit report retrieval upon successful comparison of said short range radio associated identifiers of said prospective debtor.

20. The process of claim 19, wherein said prospective creditor identifying information includes an identifier of said short range radio at said facility of said prospective creditor;
wherein said received credit request from said prospective creditor includes said short range radio associated identifier of said prospective creditor; and
said credit report retrieval is further conditioned upon successful comparison of said short range radio associated identifiers of said prospective creditor.
